(19) United States
(12) Patent Application Publication
(10) Pub. No.: US 2006/0132504 A1
(43) Pub. Date: Jun. 22, 2006

(54) Content combining apparatus and method

(75) Inventor: Yoshitaka Tobita, Fuchu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/216,106

(22) Filed: Sep. 1, 2005

(30) Foreign Application Priority Data
Dec. 21, 2004 (JP) 2004-369677

(51) Int. Cl. G09G 5/00

(52) U.S. Cl. 345/629

(57) ABSTRACT

A content combining apparatus of this invention includes a control unit which designates, to a content distributing apparatus, a playback condition for the playback of content to be distributed from a content distributing apparatus and a playback condition for the playback of content to be read out from a recording medium. A receiving unit receives the content distributed from the content distributing apparatus in accordance with the playback condition designated by the control unit. This apparatus also includes a circuit which combines the received content and the content read out from the recording medium such that scenes to be simultaneously displayed are synchronously displayed on a video display unit so as to be correlated with each other.

### CROSS-REFERENCE TO RELATED APPLICATIONS

This application is based upon and claims the benefit of priority from prior Japanese Patent Application No. 2004-369677, filed Dec. 21, 2004, the entire contents of which are incorporated herein by reference.

### BACKGROUND OF THE INVENTION

1. Field of the Invention

The present invention relates to a content combining apparatus and method which are applied to, for example, an HD DVD player or the like to combine and display a plurality of image content items in the same window.

2. Description of the Related Art

As is known, a content combining apparatus which combines and outputs a plurality of image content items has been developed.

For example, Jpn. Pat. Appln. KOKAI Publication No. 2004-15224 discloses a technique of superimposing and displaying broadband content distributed from a server as a sub-window and a broadcast video as a main window in a TV receiver. In addition, Jpn. Pat. Appln. KOKAI Publication No. 2003-179869 discloses a technique of combining and displaying an on-air video and ordinary playback video/special playback video in a digital broadcasting/recording/playback apparatus comprising a main window video signal generating unit and sub-window video signal generating unit. Furthermore, Jpn. Pat. Appln. KOKAI Publication No. 2003-169315 discloses a technique of digitizing the content/sub-content/CM of one program, separately distributing them to a viewer, displaying the content items in sub-windows on the viewer side, and allowing the viewer to switch between a sub-window and a main window by designating a displayed sub-content.

Such a conventional content combining apparatus, however, has the following problem.

According to any of the techniques disclosed in Jpn. Pat. Appln. KOKAI Publication Nos. 2004-15224, 2003-179869, and 2003-169315, a plurality of content items are simultaneously displayed in a single display window. However, these content items are only displayed independently without there being any relationship between the times. Such an operation is suitable for simultaneously viewing a plurality of unrelated content items such as sports and drama programs.

There may be a case of viewing a plurality of related content items while correlating them with each other, instead of simultaneously viewing a plurality of unrelated content items. This includes, for example, a case wherein while a movie (to be referred to as “content A” hereinafter) is displayed, content (to be referred to as “content B” hereinafter) such as a comment on each scene of the movie or an episode about the scene is simultaneously displayed.

Displaying a plurality of related content items, i.e., content A and B, in the same display window in this manner makes it possible to provide the viewer with more amusement to view the content as compared with a case wherein only the movie is displayed. In this case, however, the two content items must be displayed at proper timings. Otherwise, when a comment on a given scene of content A is made in content B, the two content items are not displayed so as to be correlated with each other and are displayed at wrong timings. This reduces the effect of displaying a plurality of related content items in the same window. If two content items are not synchronized with each other, while, for example, “this is the scene in question” is displayed in content B, an irrelevant scene is displayed in content A.

### BRIEF SUMMARY OF THE INVENTION

According to an embodiment of the present invention, a content combining apparatus comprises a designating unit configured to designate, to a content distributing side, a first playback condition for playback of content to be distributed from the content distributing side, a receiving unit configured to receive a plurality of content distributed from the content distributing side in accordance with the first playback condition designated by the designating unit, and a combining unit configured to combine a plurality of content received by the receiving unit such that scenes to be simultaneously displayed are synchronously displayed in the same display window so as to be correlated with each other.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a conceptual view showing an example of a content combining apparatus to which a content combining method according to the first embodiment of the present invention is applied;

FIG. 2 is a functional block diagram showing an example of the content combining apparatus to which the content combining method according to the first embodiment of the present invention is applied;

FIG. 3 is a conceptual view for explaining a scene synchronizing method for a case wherein content B is displayed from some halfway point during the display of content A;

FIG. 4 is a view showing an example of a resolution table;

FIG. 5 is a schematic view showing an example of a window in which combined content is displayed;

FIG. 6 is a view showing an example of the flow of processing in the content combining apparatus to which the combining method according to the first embodiment of the present invention is applied;

FIG. 7 is a conceptual view showing an example of a content combining apparatus to which a content combining method according to the second embodiment of the present invention is applied; and

FIG. 8 is a functional block diagram showing an example of the content combining apparatus to which the content combining method according to the second embodiment of the present invention is applied.

### DETAILED DESCRIPTION OF THE INVENTION

The best mode for carrying out the present invention will be described below with reference to the views of the accompanying drawing.

### FIRST EMBODIMENT

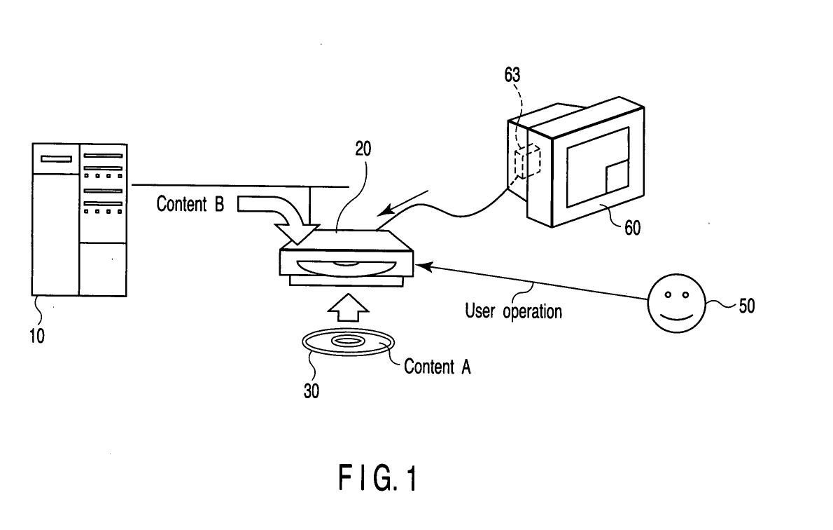

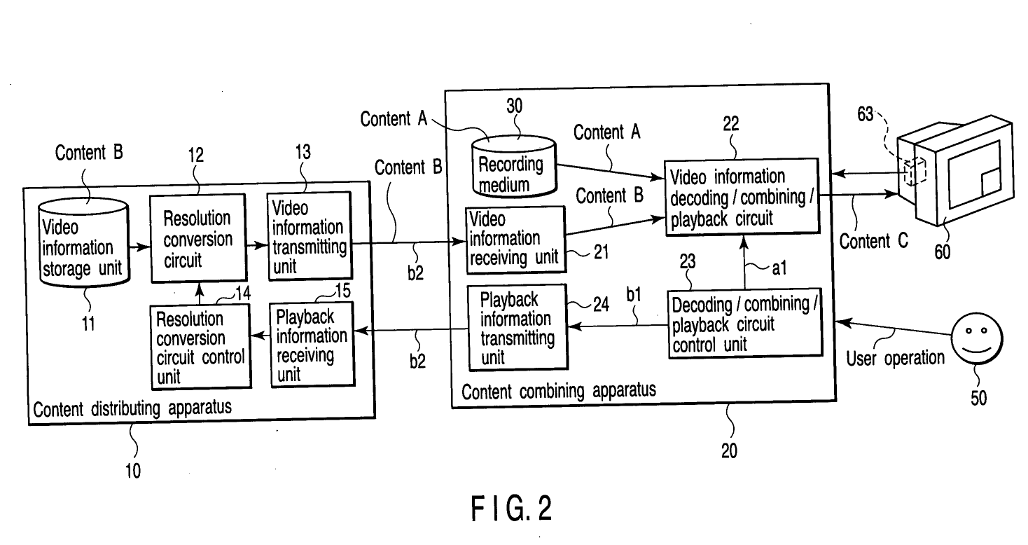

FIG. 1 is a conceptual view showing an example of a content combining apparatus 20 to which a content combining method according to the first embodiment of the present invention is applied. FIG. 2 is a functional block diagram showing an example of the content combining apparatus 20.

The content combining apparatus 20 to which the content combining method according to this embodiment is applied has a reading function of reading out a content A recorded on a recording medium 30 such as a DVD or HD, like, for example, an HD DVD player. The content combining apparatus 20 causes a video display unit 60 to combine and display one or a plurality of contents B distributed from a content distributing apparatus 10 which a content distributing side such as a broadcasting station has and the content A read out from the recording medium 30 in such a manner that scenes of the respective contents A and B which are simultaneously displayed are synchronized with each other so as to be correlated with each other.

The content combining apparatus 20 further comprises a video information receiving unit 21, video information decoding/combining/playback circuit 22, decoding/combining/playback circuit control unit 23, and playback information transmitting unit 24.

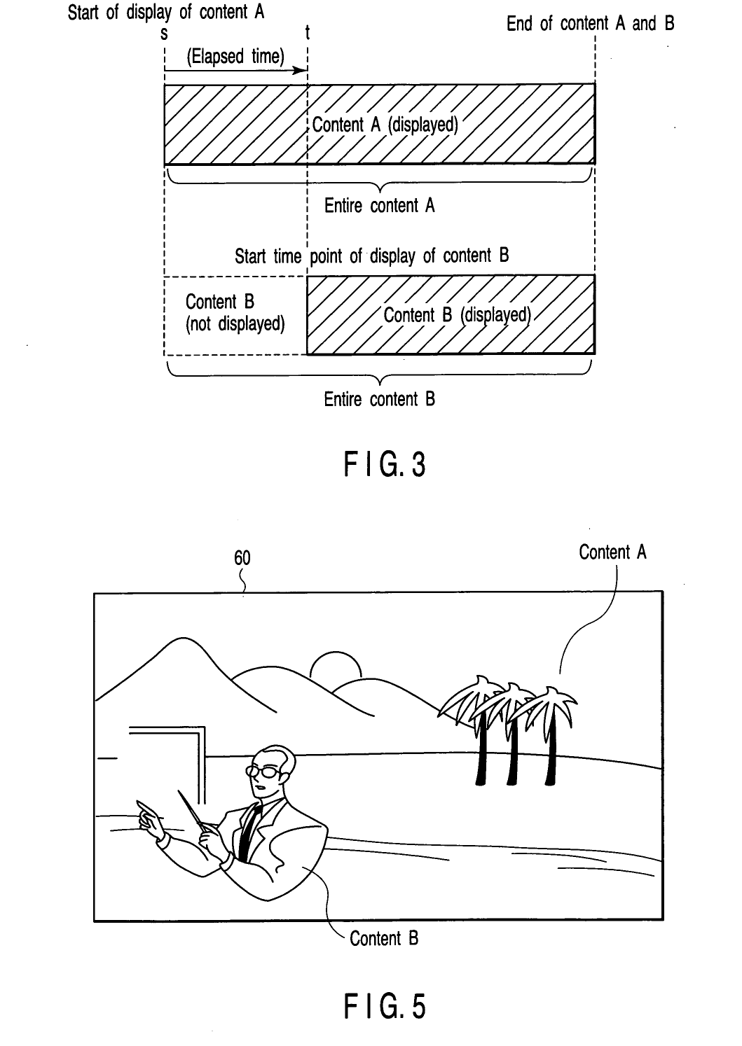

The decoding/combining/playback circuit control unit 23 designates, to the playback information transmitting unit 24, a playback condition b1 for the playback of the content B to be distributed from the content distributing apparatus 10, and also designates, to the video information decoding/combining/playback circuit 22, a playback condition a1 for the playback of the content A to be read out from the recording medium 30 in accordance with operation inputs from a user 50. The playback condition a1 contains the transparency (alpha value) of the content A to be displayed by the video display unit 60 and the display positions and display sizes of the contents A and B. The playback condition b1 contains the transparency (alpha value) of the content B to be displayed by the video display unit 60 and the display positions and display sizes of the contents A and B. In addition, the contents A and B are not necessarily displayed at the same time. For example, it is possible to display only the content A first and then additionally display the content B at an arbitrary timing. In this case, the playback condition b1 also contains an elapsed time from the display start of the content A. As shown in FIG. 3, this makes it possible to display the content B after an elapsed time t from the start of the display of the content A at a display start time s. That is, the content B is not displayed in the interval between the beginning portion and the portion corresponding to the elapsed time t. With this operation, even in a case wherein while only the content A is displayed, the content B is additionally displayed from some midpoint in the display operation, the two contents A and B can be displayed at proper timings. This makes it possible to display the two contents A and B such that the display contents are correlated with each other.

The content B distributed from the content distributing apparatus 10 may comprise a plurality of contents (contents B1, B2, . . . , Bn) as well as a single content. When a plurality contents are to be distributed, the user 50 designates the playback condition b1 for each of the contents B1, B2, . . . , Bn.

Upon receiving the playback condition b1 from the decoding/combining/playback circuit control unit 23, the playback information transmitting unit 24 converts the playback condition b1 into playback information b2 which can be recognized by the content distributing apparatus 10, and transmits the playback information b2 to the content distributing apparatus 10.

The content distributing apparatus 10 comprises a video information storage unit 11, resolution conversion circuit 12, video information transmitting unit 13, resolution conversion circuit control unit 14, and playback information receiving unit 15. The playback information receiving unit 15 receives the playback information b2 transmitted from the playback information transmitting unit 24 of the content combining apparatus 20. The playback information receiving unit 15 sends the received playback information b2 to the resolution conversion circuit control unit 14.

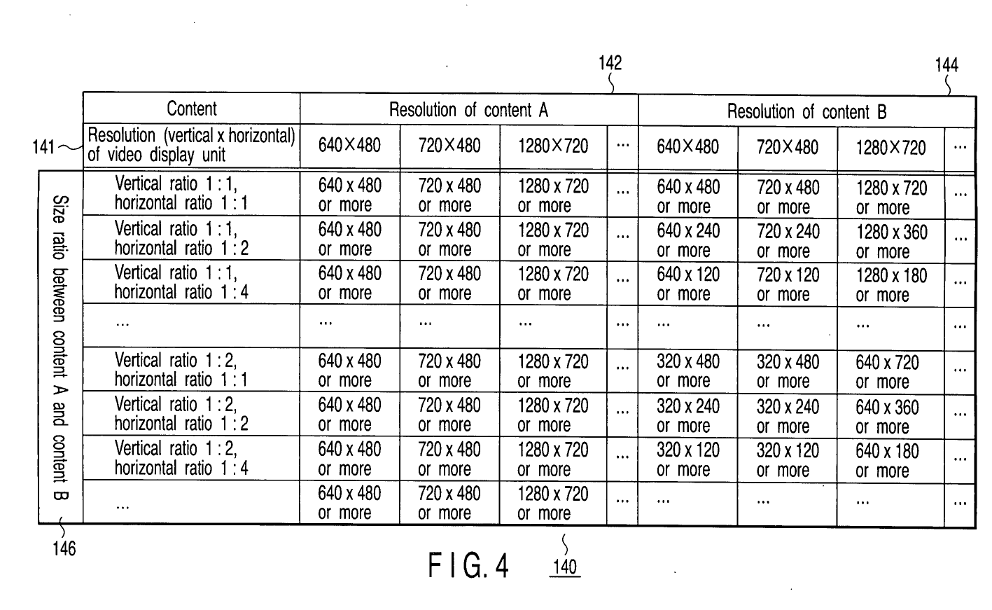

The resolution conversion circuit control unit 14 includes a resolution table 140 like that shown in FIG. 4. The resolution conversion circuit control unit 14 refers to the resolution table 140 to determine resolutions 142 and 144 with which the contents A and B are displayed by the video display unit 60, on the basis of a resolution 141 of the video display unit 60 which is written in advance and the display sizes of the contents A and B which are contained in the playback information b2 from the playback information receiving unit 15, and outputs the determined resolutions 142 and 144 of the contents A and B to the resolution conversion circuit 12. For example, the resolution 142 of the video display unit 60 is 640×480, and the display size of the content A is a full screen size. If size ratios 146 between the content A and the content B are 1:1 in the vertical direction and 1:4 in the horizontal direction, the resolution 142 of the content A is determined to be 640×480 or more, and the resolution 144 of the content B is determined to be 640×120 or more.

The resolution conversion circuit 12 reads out the compressed video data of the content B stored in the video information storage unit 11. The resolution conversion circuit 12 then converts the resolution of the readout content B into the resolution of the content B which is determined by the resolution conversion circuit control unit 14. The content B whose resolution is converted into this resolution is sent, to the video information transmitting unit 13, together with the playback information b2.

The video information transmitting unit 13 distributes the content B and playback information b2, sent from the resolution conversion circuit 12, to the content combining apparatus 20 which has requested the content B, through the Internet or by broadcasting.

The video information receiving unit 21 of the content combining apparatus 20 receives the content B and playback information b2 distributed from the video information transmitting unit 13 through the Internet or by broadcasting, and outputs the received content B and playback information b2 to the video information decoding/combining/playback circuit 22.

The video information decoding/combining/playback circuit 22 reads out the content A from the recording medium 30, and converts (decodes) the readout content A into decompressed video information in accordance with the playback condition a1 and the resolution of the content A contained in the playback information b2 which are sent from the decoding/combining/playback circuit control unit 23. In addition, the video information decoding/combining/playback circuit 22 converts (decodes) the content B from the video information receiving unit 21 into decompressed video information in accordance with the playback information b2. The contents A and B which have undergone this conversion processing are combined such that scenes to be simultaneously displayed are synchronized so as to be correlated with each other. A content C after this combining operation is then output to the video display unit 60.

The video display unit 60 displays the combined content C output from the video information decoding/combining/playback circuit 22 in a window. FIG. 5 is a schematic view showing an example of the window in which the content C is displayed. The content A (displaying a scenic image in a resort) is displayed in a full screen size in accordance with the playback condition a1, and the content B (displaying a person who is making a comment on the scenic image displayed in the content A) is displayed on the lower left side of the window in accordance with the display position, display size, and transparency (alpha value) designated by the playback condition b1.

Note that the content combining apparatus 20 according to this embodiment can always change the playback conditions a1 and b1 from the decoding/combining/playback circuit control unit 23 by setting new playback conditions and display a content under the new playback conditions even during the playback of the content C by the video display unit 60.

The video display unit 60 includes a resolution notifying unit 63. The resolution notifying unit 63 notifies the video information decoding/combining/playback circuit 22 of the content combining apparatus 20 of the optimal resolution of the content C, which is determined from the performance of the video display unit 60, through, for example, the D terminal or HDMI.

Upon being notified of the optimal resolution in this manner, the video information decoding/combining/playback circuit 22 converts the resolution of the content C to the notified optimal resolution, and outputs the converted content C to the video display unit 60. With this operation, the video display unit 60 displays the content C in a window with the optimal resolution.

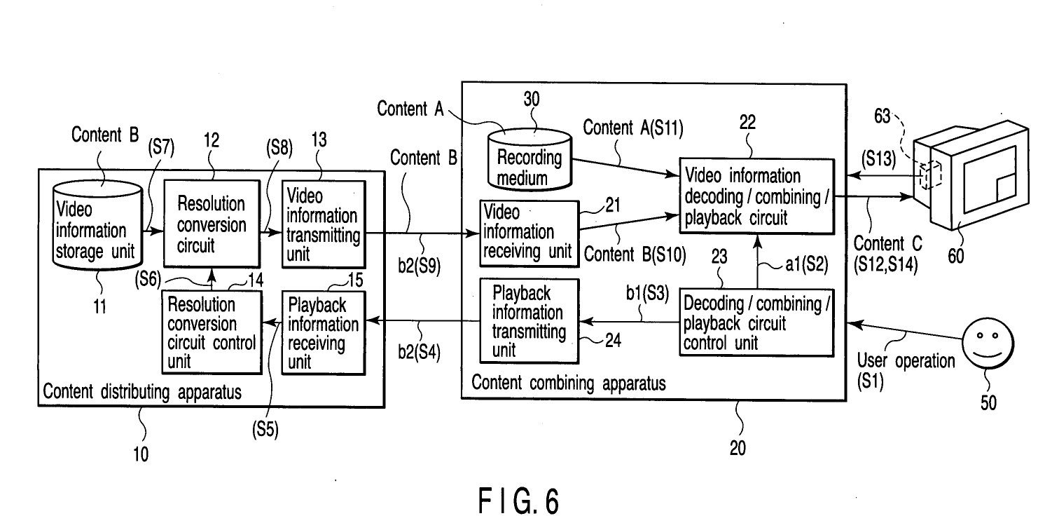

The operation of the content combining apparatus 20 to which the content combining method according to this embodiment of the present invention having the above arrangement is applied will be described next with reference to the processing flowchart of FIG. 6.

When the content combining apparatus 20 to which the content combining method according to this embodiment is to be operated, the user 50 performs necessary setting input through the decoding/combining/playback circuit control unit 23 (S1). With this operation, the input items are set with respect to the content distributing apparatus 10, including the playback condition b1 for the playback of the content B to be distributed from the content distributing apparatus 10 and the playback condition a1 for the playback of the content to be read out from the recording medium 30. The playback condition a1 contains the transparency (alpha value) of the content A displayed on the video display unit 60 and the display positions and display sizes of the contents A and B. The playback condition b1 contains the transparency (alpha value) of the content B displayed on the video display unit 60 and the display positions and display sizes of the contents A and B. When the content A is to be displayed first and then the content B is to be additionally displayed from a given time point, the playback condition b1 contains an elapsed time from the start of the display of the content A. The content B to be distributed from the content distributing apparatus 10 may comprise a plurality of contents (contents B1, B2, . . . , Bn) as well as a single content. When the user wants to receive a plurality of distributed contents, he/she designates the playback condition b1 for each of the contents B1, B2, . . . , Bn.

The playback condition a1 input to the decoding/combining/playback circuit control unit 23 in step S1 is output to the video information decoding/combining/playback circuit 22 (S2), and the playback condition b1 is output to the playback information transmitting unit 24 (S3).

The playback information transmitting unit 24 converts the playback information into the playback information b2, which can be recognized by the content distributing apparatus 10, on the basis of the playback condition b1 output from the decoding/combining/playback circuit control unit 23 in step S3. The playback information b2 is then transmitted to the content distributing apparatus 10 and received by the playback information receiving unit 15 (S4). The playback information b2 is further sent from the playback information receiving unit 15 to the resolution conversion circuit control unit 14 (S5).

The resolution conversion circuit control unit 14 is provided with the resolution table 140 like that shown in FIG. 4. The resolution conversion circuit control unit 14 refers to the resolution table 140 to determine the resolutions 142 and 144 with which the contents A and B are displayed by the video display unit 60, on the basis of the resolution 141 of the video display unit 60 and the playback information b2 from the playback information receiving unit 15. The determined resolutions 142 and 144 are output from the resolution conversion circuit control unit 14 to the resolution conversion circuit 12 (S6).

The resolution conversion circuit 12 reads out the compressed video data of the content B stored in the video information storage unit 11 (S7). The resolution of the content B is converted into the resolution determined by the resolution conversion circuit control unit 14. The resultant content B is sent to the video information transmitting unit 13 together with the playback information b2 (S8).

The content B and playback information b2 sent to the video information transmitting unit 13 are then distributed to the content combining apparatus 20, which has requested the content B, through, for example, the Internet or by broadcasting (S9).

The content B and playback information b2 distributed from the video information transmitting unit 13 of the content distributing apparatus 10 in this manner are received by the video information receiving unit 21 of the content combining apparatus 20 and output to the video information decoding/combining/playback circuit 22 (S10).

The video information decoding/combining/playback circuit 22 reads out the content A from the recording medium 30 (S11). The readout content A is converted (decoded) into decompressed video information in accordance with the playback condition a1 from the decoding/combining/playback circuit control unit 23 and the resolution of the content A contained in the playback information b2. The content B sent from the video information receiving unit 21 in step S10 is converted (decoded) into decompressed video information in accordance with the playback information b2. The converted contents A and B are then synchronously combined such that scenes to be simultaneously displayed are correlated with each other, and the resultant content C is output to the video display unit 60 (S12).

If an elapsed time is contained in the playback information b2, a portion of the video corresponding to the content B which corresponds to the interval between the start of the display of the content A at the display start time point s and a portion corresponding to the elapsed time t is not displayed, and when the elapsed time t has expired, a video portion from the elapsed time t is then displayed, as shown in FIG. 3. This makes it possible to display the contents A and B at proper timings. Even if the contents A and B are not simultaneously displayed, the display contents of the contents A and B are displayed so as to be correlated with each other.

The content C output in step S12 is displayed on the screen of the video display unit 60 such that the content A is displayed in accordance with the display position, display size, and transparency (alpha value) designated by the playback condition a1 and the resolution contained in the playback information b2, and the content B is displayed in accordance with the display position, display size, and transparency (alpha value) designated by the playback condition b1, as shown in, for example, FIG. 5.

The video display unit 60 includes the resolution notifying unit 63. The video information decoding/combining/playback circuit 22 of the content combining apparatus 20 is notified through, for example, the D terminal or HDMI of the optimal resolution of the content C which is determined by the resolution notifying unit 63 on the basis of the performance of the video display unit 60 (S13).

When the optimal resolution is notified in this manner, the resolution of the content C is converted into the optimal resolution by the video information decoding/combining/playback circuit 22. The resultant content is output to the video display unit 60 to be displayed thereon (S14). This allows the video display unit 60 to display the content C on the screen with the optimal resolution.

As described above, the content combining apparatus 20 according to this embodiment can always change the playback conditions a1 and b1 from the decoding/combining/playback circuit control unit 23 by setting new playback conditions and display a content under the new playback conditions at a desired timing even during the playback of the content C by the video display unit 60.

As described above, in the content combining apparatus 20 to which the content combining method according to this embodiment of the present invention is applied, when a video obtained by combining a plurality contents is to be displayed on the video display unit 60 such that scenes of the respective contents are synchronously displayed so as to be correlated with each other, the display positions, display sizes, transparencies (alpha values), and display start times of the respective contents constituting the combined video can be arbitrarily set at desired timings, and the contents can be displayed in accordance with the settings.

Even if the contents A and B are not simultaneously started to be displayed, a portion of the content B which corresponds to the interval between the start of the display of the content A at the display start time s and a portion corresponding to the elapsed time t is not displayed, and the content B can be displayed from a halfway point of time when the elapsed time t has expired, as shown in FIG. 3. With this operation, even if the contents A and B are not simultaneously started to be displayed, the display contents of the contents A and B can be displayed so as to be correlated with each other.

### SECOND EMBODIMENT

The first embodiment has exemplified the case wherein the content A read out from the content combining apparatus 20 and the content B distributed from the content distributing apparatus 10 are combined to be displayed on the same display screen. However, the content combining method according to the present invention and the content combining apparatus to which the method is applied are not limited to this case. The content combining apparatus can also combine only a plurality of contents B distributed from the content distributing apparatus without reading out any content so as to display the combined content on the same display screen. This will be described as the second embodiment.

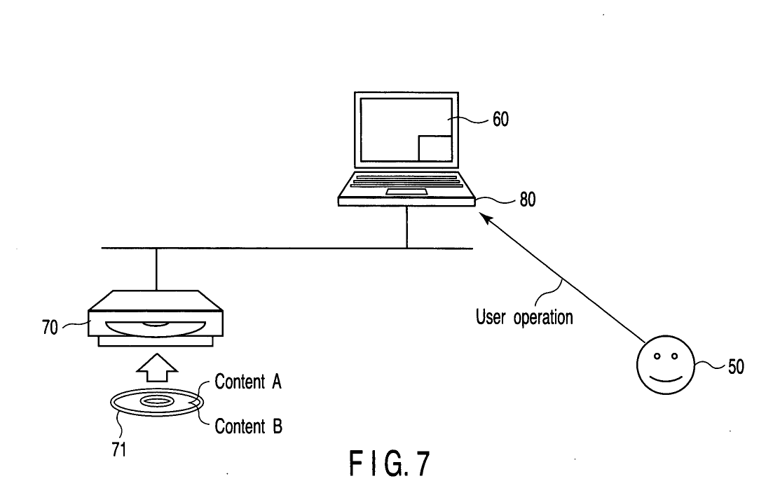

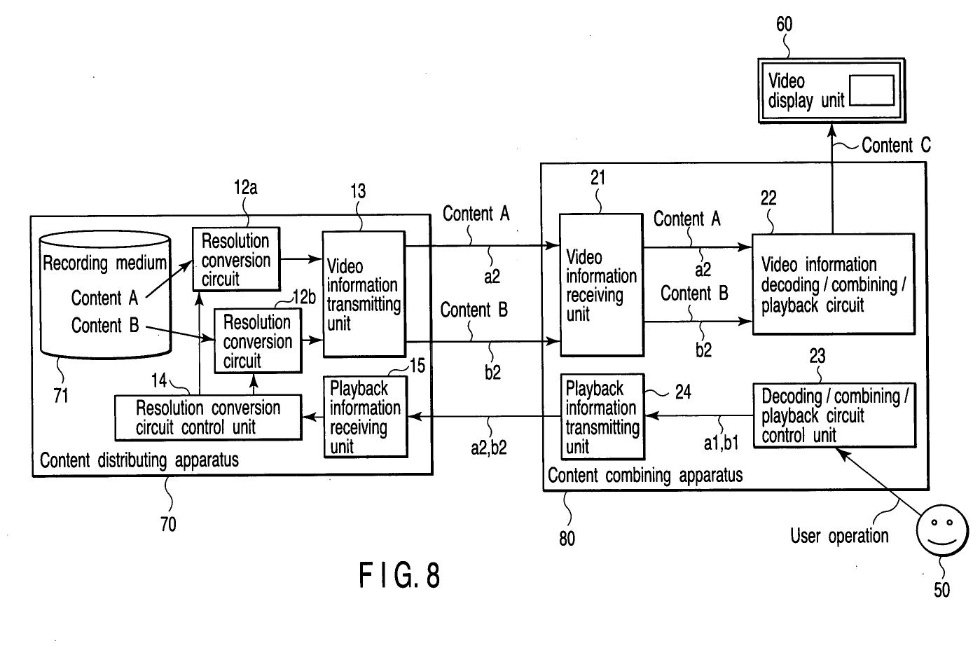

FIG. 7 is a conceptual view showing an example of a content combining apparatus 80 to which a content combining method according to the second embodiment of the present invention is applied. FIG. 8 is a functional block diagram showing an example of the content combining apparatus 80. Note that the same reference numerals as in FIGS. 1 and 2 denote the same parts in FIGS. 7 and 8, and a detailed description thereof will be omitted. The different points between the first and second embodiments will be mainly described below.

In this embodiment of the present invention, the content combining apparatus 80 does not read out any contents by itself and hence does not include the recording medium 30 shown in FIG. 2. Since the content combining apparatus 80 acquires both contents A and B in the first embodiment from a content distributing apparatus 70, a decoding/combining/playback circuit control unit 23 sends both playback conditions a1 and b1 to a playback information transmitting unit 24.

Upon receiving the playback conditions a1 and b1 from the decoding/combining/playback circuit control unit 23, the playback information transmitting unit 24 converts pieces of playback information into pieces of playback information a2 and b2 which can be recognized by the content distributing apparatus 70, and transmits the pieces of playback information a2 and b2 to the content distributing apparatus 70.

A playback information receiving unit 15 receives the pieces of playback information a2 and b2 transmitted from the playback information transmitting unit 24 of the content combining apparatus 20. The playback information receiving unit 15 sends the received pieces of playback information a2 and b2 to a resolution conversion circuit control unit 14.

The resolution conversion circuit control unit 14 comprises a resolution table 140 like that shown in, for example, FIG. 4. The resolution conversion circuit control unit 14 refers to the resolution table 140 to determine a resolution 141 of a video display unit 60 which is written in advance and resolutions 142 and 144, with which the contents A and B are displayed on the video display unit 60, on the basis of the pieces of playback information a2 and b2 from the playback information receiving unit 15, and outputs the determined resolutions 142 and 144 to resolution conversion circuits 12a and 12b. As described above, this embodiment of the present invention comprises resolution conversion circuits 12 in accordance with the number of contents requested by the content combining apparatus 80.

The resolution conversion circuits 12a and 12b read out the compressed video data of the contents A and B recorded on a recording medium 71, and convert the resolutions of the readout contents A and B into the resolutions designated by the resolution conversion circuit control unit 14. The contents A and B whose resolutions have been converted into these resolutions are then sent to a video information transmitting unit 13, together with the pieces of playback information a2 and b2.

The video information transmitting unit 13 distributes the contents A and B and pieces of playback information a2 and b2 sent from the resolution conversion circuits 12a and 12b to the content combining apparatus 80 through, for example, the Internet or by broadcasting.

A video information receiving unit 21 of the content combining apparatus 80 receives the contents A and B and pieces of playback information a2 and b2 distributed from the video information transmitting unit 13 of the content distributing apparatus 70 through, for example, the Internet or by broadcasting, and outputs the received contents A and B and pieces of playback information a2 and b2 to a video information decoding/combining/playback circuit 22.

The video information decoding/combining/playback circuit 22 converts (decodes) the content A from the video information receiving unit 21 into decompressed video information in accordance with the playback information a2 and the resolution of the content A which is contained in the playback information b2. The video information decoding/combining/playback circuit 22 also converts (decodes) the content B from the video information receiving unit 21 into decompressed video information in accordance with the playback information b2. The video information decoding/combining/playback circuit 22 then synchronously combines the contents A and B such that scenes to be simultaneously displayed are correlated with each other. The video information decoding/combining/playback circuit 22 outputs a combined content C to the video display unit 60.

With the above arrangement, according to this embodiment, even if the content combining apparatus 80 does not read out any contents by itself and use only a plurality contents distributed from the content distributing apparatus 70, the content combining apparatus 80 can combine the contents so as to display them on the same display screen. That is, the content combining apparatus 80 to which the content combining method according to the second embodiment of the present invention is applied can have the same function and effect as those of the content combining apparatus 20 to which the content combining method according to the first embodiment of the present invention is applied.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A content combining apparatus comprising:
a designating unit configured to designate, to a content distributing side, a first playback condition for playback of content to be distributed from the content distributing side;
a receiving unit configured to receive a plurality of content distributed from the content distributing side in accordance with the first playback condition designated by the designating unit; and
a combining unit configured to combine a plurality of content received by the receiving unit such that scenes to be simultaneously displayed are synchronously displayed in the same display window so as to be correlated with each other.

2. A content combining apparatus including a reading unit configured to read out content recorded on a recording medium, comprising:
a designating unit configured to designate, to a content distributing side, a first playback condition for playback of content to be distributed from the content distributing side, and designate, to the reading unit, a second playback condition for playback of content to be read out from the reading unit;
a receiving unit configured to receive one or a plurality of content distributed from the content distributing side in accordance with the first playback condition designated by the designating unit; and
a combining unit configured to combine one or a plurality of content received by the receiving unit and content read out by the reading unit in accordance with the second playback condition designated by the designating unit such that scenes to be simultaneously displayed are synchronously displayed in the same display window so as to be correlated with each other.

3. An apparatus according to claim 1 or 2, wherein the designating unit designates the first playback condition for each content to be received by the receiving unit.

4. An apparatus according to claim 1 or 2, wherein the playback condition contains a resolution of each content displayed in the display window.

5. An apparatus according to claim 1 or 2, wherein the playback condition contains a transparency of each content displayed in the display window.

6. An apparatus according to claim 1 or 2, wherein the playback condition contains a display position and display size of each content displayed in the display window.

7. An apparatus according to claim 1 or 2, wherein when display start times of the respective content differ from each other, a display start time point of content other than content displayed first is set to a time point when an elapsed time from a display start time of the content displayed first is elapsed from a head of the content other than the content displayed first.

8. A content combining method comprising:
designating, to a content distributing side, a first playback condition for playback of content to be distributed from the content distributing side;
receiving a plurality of content distributed from the content distributing side in accordance with the designated first playback condition; and
combining said plurality of received content such that scenes to be simultaneously displayed are synchronously displayed in the same display window so as to be correlated with each other.

9. A method according to claim 8, wherein
the method is applied to a content combining apparatus including a reading unit configured to read out content recorded on a recording medium, the method further comprising:
designing a second playback condition for playback of content to be read out from the reading unit to the reading unit,
receiving one or a plurality of content distributed from the content distributing side in accordance with the first designated playback condition, and
combining said one or said plurality of received content and content read out by the reading unit in accordance with the second playback condition are combined such that scenes to be simultaneously displayed are synchronously displayed in the same display window so as to be correlated with each other.

10. A method according to claim 8 and 9, wherein the first playback condition is designated for each of the content to be received.

11. A method according to claim 8 or 9, wherein the playback condition includes a resolution of each content to be displayed in the same window.

12. A method according to claim 8 or 9, wherein the playback condition includes a transparency of each content to be displayed in the same window.

13. A method according to claim 8 or 9, wherein the playback condition includes a display position and display size of each content to be displayed in the same window.

14. A method according to claim 8 or 9, wherein when display start times of the respective content differ from each other, a display start time point of content other than content displayed first is set to a time point when an elapsed time from a display start time of the content displayed first is elapsed from a head of the content other than the content displayed first.
